(19) United States
(12) Patent Application Publication
(10) Pub. No.: US 2009/0127288 A1
(43) Pub. Date: May 21, 2009

(54) Method and Device for Venting and Eliminating Unwanted Material of a Dispensing Appliance

(75) Inventor: Wilhelm A. Keller, Merlischachen (CH)

Correspondence Address: FOLEY AND LARDNER LLP;SUITE 500, 3000 K STREET NW, WASHINGTON, DC, 20007, US

(73) Assignee: MEDMIX SYSTEMS AG

(21) Appl. No.: 11/921,441

(22) PCT Filed: Jun. 15, 2006
(86) PCT No.: PCT/CH2006/000326

§ 371 Date: Dec. 3, 2007

(30) Foreign Application Priority Data
Jun. 29, 2005 (CH) 1097/05
Aug. 29, 2005 (CH) 1408/05
Nov. 3, 2005 (CH) 1761/05
Dec. 29, 2005 (CH) 2091/05

(51) Int. Cl. B67D 5/06; B67D 5/58

(52) U.S. Cl. 222/108; 222/1; 222/189.06

(57) ABSTRACT

In the method for venting and eliminating liquid material of a dispensing appliance prior to dispensing, the air as well as unusable material are eliminated via a deviating channel and the conditioned material is dispensed via a dispensing channel. The device for implementing the method for eliminating unusable liquid material and for venting a dispensing appliance is provided with a valve assembly for selectively connecting the inlet area of the device with a deviating channel or with an outlet. The deviating channel is connected to a collecting container having venting means. The method and the device according to the invention allow advantageously venting a multicomponent dispensing appliance and leveling the components as well as eliminating incompletely mixed components in the starting phase after the latter have left the mixer elements, thereby ensuring a flawless application. In an advantageous development, a device is provided that avoids the occurrence of an overpressure during dispensing.

This is a national stage of PCT/CH2006/00326 filed Jun. 15, 2006, which claims priority to Switzerland applications nos 1097/05, filed Jun. 29, 2005, 1408/05 filed Aug. 29, 2005, 1761/05 filed Nov. 3, 2005 and 2091/05 filed Dec. 29, 2005, the respective disclosures of which are hereby incorporated by reference in their entireties.

The present invention relates to a method for venting and eliminating liquid material of a dispensing appliance prior to the dispensing operation according to claim 1 as well as for venting, leveling, and eliminating incompletely mixed components after the mixing operation of at least two components, and to a device for implementing the method according to claim 1.

U.S. Pat. No. 6,079,868 discloses a device for mixing and delivering a curable biomaterial, the device comprising, besides the usual delivery conduit, a mechanism for controllably shunting an initial portion of mixed biomaterial. This shunting mechanism allows to direct material either to the deliver conduit or to the outlet shunt before, during or after dispensing of the biomaterial.

When multicomponent cartridges are being filled, there are filling tolerances that lead to different volumes or to filling level differences between two or multiple containers. The result of these filling tolerances is that the components are not synchronously dispensed or are not or only incompletely mixed at the beginning of the dispensing operation. Therefore, the components have to be leveled prior to being dispensed and applied. Such a leveling device for syringe and cartridge containers is disclosed in WO 2004/100854.

Another negative influence upon dispensing is the presence of air in the containers as well as in the mixer. Air bubbles in the containers are the result of inadequate venting during cartridge filling or may develop due to subsequent processes such as heating, freezing, sterilization, or irradiation. During dispensing, the air resp. gas is compressed, thereby affecting the mixing ratio and furthermore leading to an unwanted early or prolonged outflow of a component. Also, in certain medical applications, the air enclosed in the mixer must not enter into the body.

Another influence may result from different viscosities of the components. Specifically, the lower viscosity component may precede in the mixer, especially when the mixer is downwardly inclined, thereby preventing a correct mixture in the initial phase. Furthermore, at the beginning of the dispensing operation, the components are only incompletely mixed due to different other factors. This means that in demanding applications, the first portion of the mixed components must not be used.

Mainly in medical applications such as e.g. minimally invasive techniques, where application instruments are directly attached to the mixer, the venting and synchronization of the components and the elimination of incompletely mixed components after the mixing operation is indispensable.

With the current state of the art, an efficient venting and leveling is complicated, requires special attention, and is impossible in the case of fast-reacting adhesives. Since the reaction already starts in the mixer, there is not enough time to connect an application instrument to the mixer after venting and leveling and to place it in the correct location in/on the patient. If it is handled incorrectly or if venting, leveling, and elimination are omitted, the two-component adhesive may fail to function.

On the background of this prior art, it is an object of the present invention to provide a method and device that allow the direct application of a vented material. This is accomplished by the method according to claim 1 and the device according to claim 5.

Another object of the present invention is to provide a method and a device that allow the direct application of a vented, leveled, and completely mixed material from a multicomponent dispensing appliance. This is accomplished by the method according to claim 2 and the device according to claim 5.

These methods and devices allow a substantial increase in safety in critical applications, particularly in medicine, since the venting and leveling operation is visualized and in preferred embodiments also automated.

The invention will be explained in more detail hereinafter with reference to drawings of exemplary embodiments.

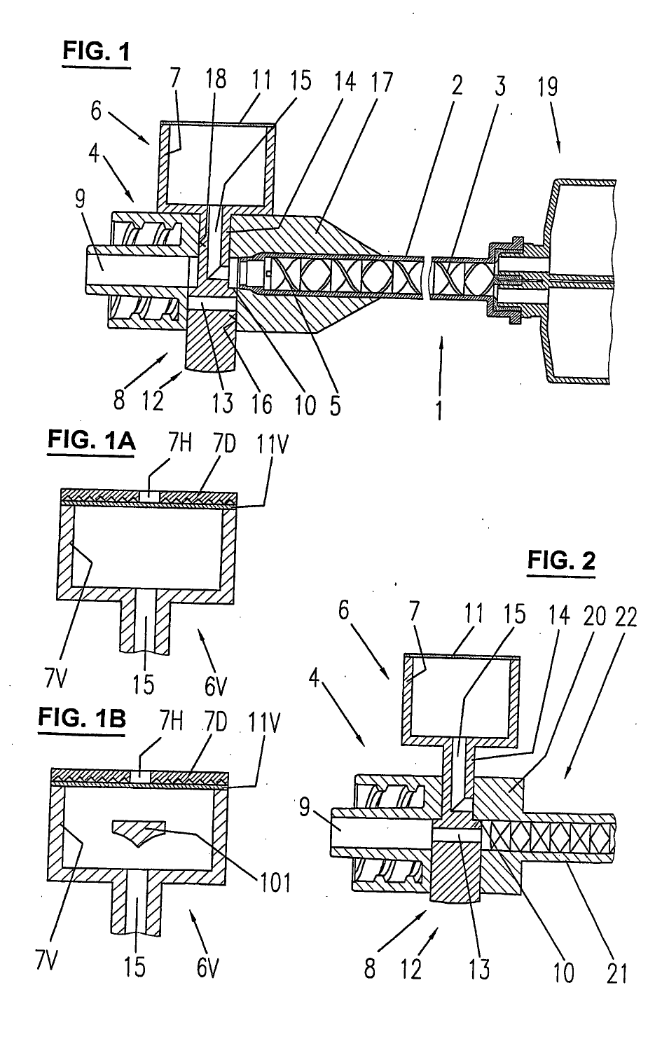

FIG. 1 shows a longitudinal section of a first exemplary embodiment of the invention in the venting position,

FIG. 1A shows a variant of the embodiment according to FIG. 1,

FIG. 1B shows another variant of the embodiment according to FIG. 1,

FIG. 2 shows a second exemplary embodiment in the dispensing position,

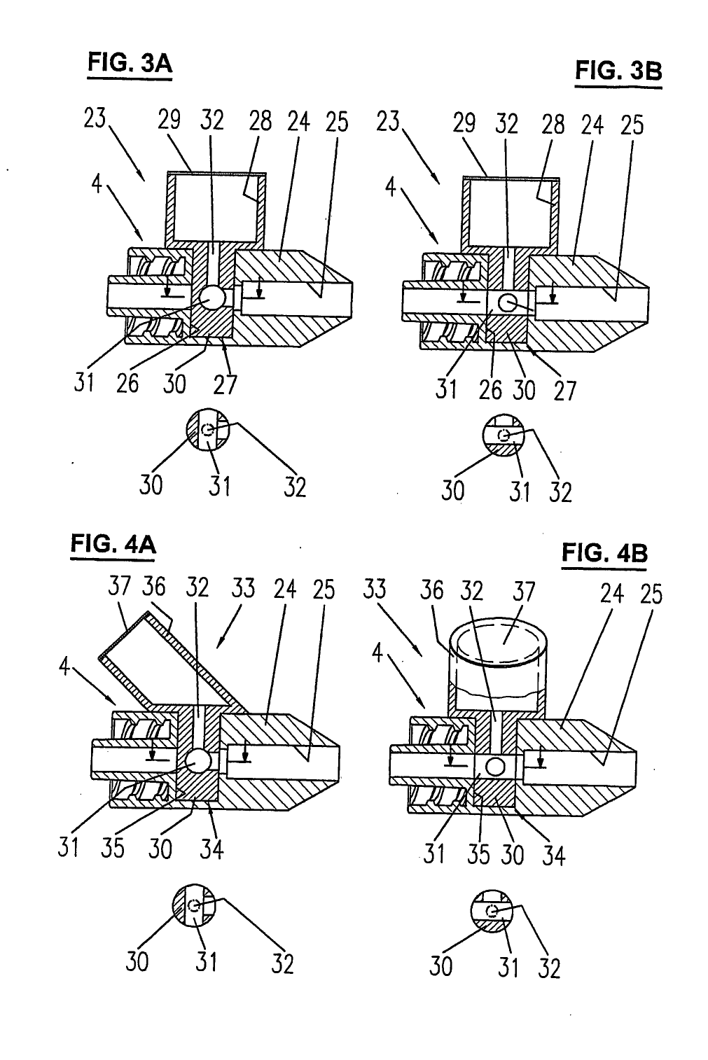

FIG. 3A shows a third exemplary embodiment in the venting position,

FIG. 3B shows the exemplary embodiment of FIG. 3A in the dispensing position,

FIG. 4A shows an embodiment variant of the example of FIG. 3A in the venting position,

FIG. 4B shows the embodiment variant of FIG. 4A in the dispensing position,

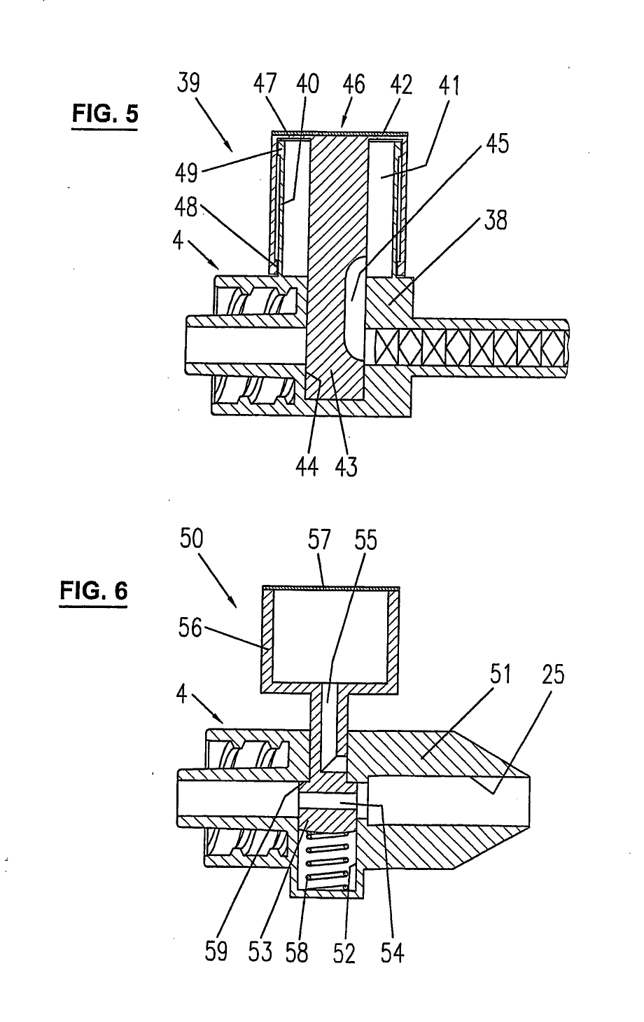

FIG. 5 shows a fourth exemplary embodiment in the venting position,

FIG. 6 shows a fifth exemplary embodiment in the dispensing position,

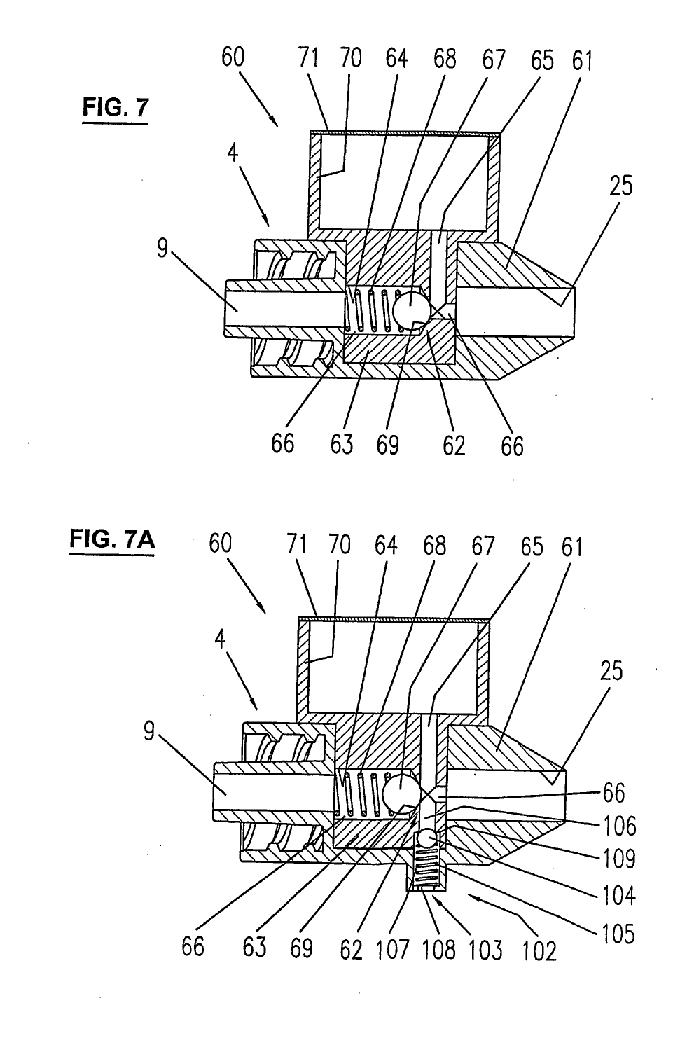

FIG. 7 shows a sixth exemplary embodiment in the venting position,

FIG. 7A shows the exemplary embodiment of FIG. 7 with an additional relief valve,

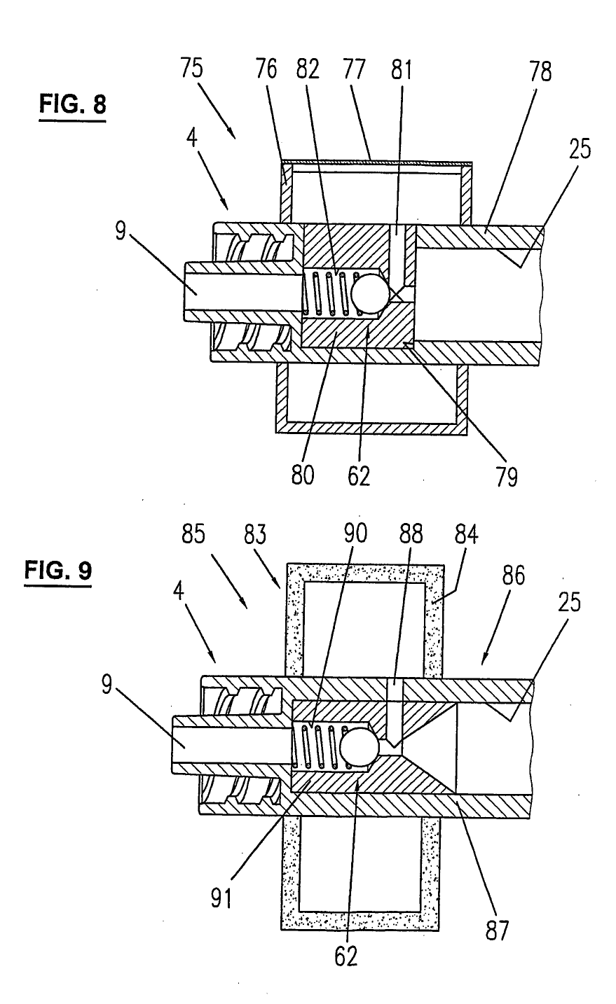

FIG. 8 shows a first variant of the embodiment of FIG. 7 in the venting position,

FIG. 9 shows a second variant of the embodiment of FIG. 7 in the venting position,

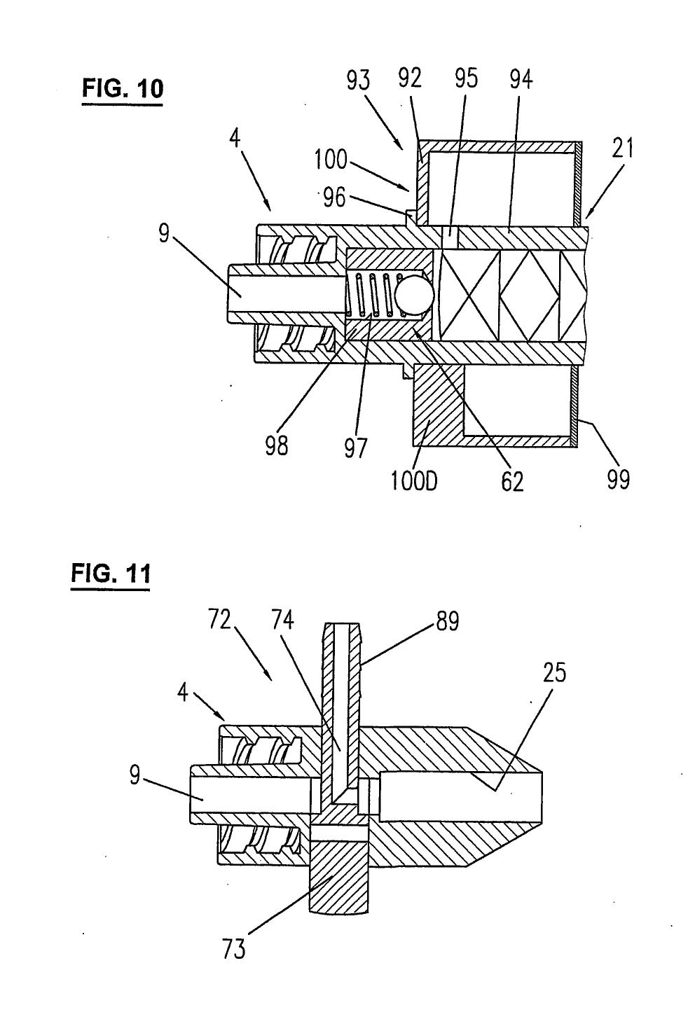

FIG. 10 shows a third variant of the embodiment of FIG. 7 in the venting position, and

FIG. 11 shows a variant of the embodiment of FIG. 1 in the venting position.

FIG. 1 shows a first exemplary embodiment comprising a multicomponent dispensing assembly 1 with a mixer that is connected to a double syringe 19. The mixer comprises a mixer housing 2 with a mixing helix 3 as well as an interface, here a Luer-Lok connector 4. Venting and leveling device 6, hereinafter referred to as device, is located at the mixer outlet, between the last element 5 of the mixing helix and the Luer-Lok connector.

This device is essentially composed of a collecting container 7 and a valve assembly 8 in order to first conduct air and material to collecting container 7 after the last mixer element 5 and subsequently dispense the mixed material that has been vented and leveled directly through outlet 9. Collecting container 7 is provided with a closure in the form of a filter 11 that is permeable to air but prevents the outflow of material. A suitable filter material for this purpose is e.g. hydrophobic, porous or provided with fine channels.

In the variant of FIG. 1A, collecting container 7V is closed with a filter 11V and a cover 7D, the filter being placed between the container and the cover. The filter may e.g. be welded, glued, or connected to the cover and the container in another manner. If a cover having a structured inner surface is used, the air can still flow to opening 7H or to several openings in the cover for being evacuated when the filter is partly moistened. This design further offers the advantage that the filter is supported and protected from mechanical influence. The inner surface may have a structure of any kind, e.g. small V-shaped grooves as in FIG. 1A or rectangular grooves, in a parallel or a checkered, crossed array.

Such a filter and cover combination is not only useful for the embodiments shown in the context of this application but for all kinds of filters in devices for leveling and venting cartridges or syringes.

In the embodiment variant according to FIG. 1B, a splash guard 101 is arranged in collecting container 6V so that the components may not squirt directly onto the filter and the cover. Such a splash guard is advantageous in all embodiments and may be designed in various ways, e.g. as a rounded wedge, as in FIG. 1B, or as a disk or in any suitable form.

In the present exemplary embodiment, the collecting container and the valve assembly are designed as a unit that is adapted to be pushed over mixer housing 2 and secured thereto. At the end of the mixer, valve body 17 is provided with a bore 16 in which a movable valve member 12 is guided that connects to collecting container 7 via a connecting member 14. Movable valve member 12 comprises a dispensing channel 13 and an angled deviating channel 15 extending inside connecting member 14 and connecting the mixer outlet to the collecting container in the illustrated position.

Connecting member 14 is guided inside another smaller bore 18 of the valve body, as appears when comparing FIG. 1 to FIG. 2. The junction between the two bores 16 and 18 forms a shoulder 10, thereby preventing an unintentional withdrawal of the movable valve member.

In FIG. 2, the device is formed integrally with mixer housing 21 of mixer assembly 22, and the valve is shown in the dispensing position with dispensing channel 13 in the let-through position. Movable valve member 12 with the container is the same as in FIG. 1.

A third exemplary embodiment is described with reference to FIGS. 3A and 3B where device 23, analogously to the embodiment according to FIG. 1, is designed as a unit that is attachable to the mixer. Here, valve body 24 is provided on its inlet side with inlet 25 and on its outlet side with Luer-Lok connector 4. Movable valve member 27 consists of a rotary plug 30 turning in a transversal bore 26 in the valve body and provided with a dispensing channel 31 and a deviating channel 32 that leads to collecting container 28 with filter 29. The collecting container is formed integrally with the rotary plug.

A comparison of the two FIGS. 3A and 3B shows that in the position of FIG. 3A, after having attached the device to a mixer outlet, the air that is present and some material may first enter into the collecting container as the dispensing appliance is operated, after which rotary plug 30 is brought to the position of FIG. 3B by rotating the collecting container and the air-free and leveled mixture can be dispensed.

In the embodiment variant of FIGS. 4A and 4B, device 33 comprises the same valve body 24 as in FIG. 3 provided with inlet 25 and Luer-Lok connector 4 and a transversal bore 35 in which rotary plug 30 with dispensing channel 31 and deviating channel 32 is arranged.

In contrast to the embodiment according to FIGS. 3A and 3B, collecting container 36 with filter 37 is arranged at an angle, e.g. 45°, with respect to the longitudinal axis of the mixer. This angle may also have a different value between 0 and 90°. The inclined arrangement of the container allows an improved venting when the dispensing appliance is directed vertically upwards for a better venting. To open dispensing channel 31, the collecting container is rotated 90°.

In FIG. 5, a fourth exemplary embodiment is illustrated that is based on the exemplary embodiment according to FIG. 2 whereas valve body 38 of device 39 and Luer-Lok connector 4 form a unit with mixer housing 21. A cylinder 40 is arranged as part of collecting container 41 on valve body 38 with Luer-Lok connector 4.

The movable valve member consists of a plug 43 that is displaceable in a transversal bore 44 in the valve body and is provided with a deviating channel 45, and at the end of which a cap 46 is arranged whose front side is provided with venting slots 47 above which filter 42 is arranged. In order to prevent that the movable valve member may be withdrawn, cap 46 comprises a circular collar 48 that cooperates with a collar 49 on cylindrical portion 40.

In the position illustrated in FIG. 5, the device is in venting mode. After venting and leveling, the movable valve member is pulled up, thus forming a dispensing channel through which the mixture can be dispensed.

In FIG. 6, a fifth exemplary embodiment is illustrated where the valve assembly is spring-loaded in order to ensure an automatic return of the valve to the dispensing position. Similarly to that according to FIG. 1, 3, or 4, device 50 is designed as a unit that is attachable to the mixer, and includes a valve body 51 with an inlet bore 25 and a Luer-Lok connector 4.

Valve body 51 is provided with a transversal bore 52 in which the movable valve member 53 is arranged. The movable valve member has a dispensing channel 54 followed by an intermediate portion provided with deviating channel 55 that leads to collecting container 56 with filter 57. A compression spring 58 is arranged between the end of the movable member and the bottom of the transversal bore. The section of the movable valve member provided with the dispensing channel has a larger diameter than the intermediate portion so that a circular collar 59 is formed at the junction between these two parts, thereby preventing that the movable valve member may be removed from the valve body.

In the position illustrated in FIG. 6, the device is in dispensing mode. If a venting and leveling operation is required, the collecting container is pressed down and the dispensing appliance is actuated until the air has escaped and the materials are leveled, whereupon the collecting container is released and dispensing may start immediately.

A spring-loaded valve member is also illustrated in the exemplary embodiment according to FIG. 7, device 60 being again designed as an attachable unit. Valve body 61 with inlet bore 25 is formed integrally with Luer-Lok connector 4. The movable valve member is designed as a nonreturn valve 62 that is arranged in a carrier member 63 arranged in a transversal bore 64 in the valve body.

Carrier member 63 comprises both deviating channel 65 and dispensing channel 66, a section of the deviating channel serving as the dispensing channel in the open position. In a manner known per se, nonreturn valve 62 is provided with a valve ball 67 that is loaded by a compression spring 68 and pushed against a valve seat 69 in carrier member 63. Carrier member 63 connects to collecting container 70 with filter 71.

This embodiment operates automatically, the air and the unwanted material first being transferred via deviating channel 65 to collecting container 70, and when the latter is filled, the valve being opened by the buildup of a higher pressure to allow the mixture to be dispensed.

In the exemplary embodiment according to FIG. 7A, an additional arrangement is illustrated that allows either avoiding or indicating an overpressure during dispensing. These functions allow a defined and complete filling of cavities. The components are leveled and vented as disclosed hereinbefore and subsequently transferred to the cavity e.g. by means of a catheter. When the cavity is filled up, the pressure increases and the pressure relief assembly either reduces the unwanted overpressure automatically by means of a pressure relief valve or via a signaling device, or the overpressure is displayed.

Such an arrangement is advantageous mainly in medicine, e.g. in the application of two-component substances as a nucleus replacement in intervertebral disks or for filling up osteoporotic bones with bone cement, to prevent overfilling.

In the exemplary embodiment of FIG. 7A, the pressure limiting or indicating device 102 is in the form of a pressure relief valve 103 consisting of a valve ball 104 loaded by a compression spring 105. Deviating channel 65 that leads to the collecting container is prolonged in the opposite direction to form a relief channel 106 and comprises an enlarged, outwardly open section 107 that is terminated by an outlet 108 of smaller diameter, the junction between the relief channel and the enlarged section being configured as a valve ball seat 109.

With this device, the starting phase and the dispensing operation remain the same as previously. When the pressure in the system increases during dispensing and the cavity is full, pressure relief valve 103 opens at a previously specified pressure, which pressure is determined by the compression spring.

Instead of a pressure relief valve it is also possible to provide a signaling device that controls the dispensing appliance, or a display device that indicates the current pressure.

The pressure relief assembly is fully effective in combination with the venting and the leveling of the components for achieving best operating conditions, but a pressure relief assembly as described with reference to FIG. 7A may also be used with the other described or with further leveling devices or alternatively without such devices, i.e. with a mixer or dispensing appliance alone.

FIG. 8 illustrates a variant of the embodiment of FIG. 7 where attachable device 75 comprises a circular collecting container 76 that is closed with a filter 77 and arranged around valve body 78. In a transversal bore 79 in the valve body, a carrier member 80 is arranged in which nonreturn valve 62 forms the movable valve member and which includes deviating channel 81 and dispensing channel 82.

In the variant of FIG. 9, collecting container 83 of attachable device 85 is made of a porous material 84 that allows air but no material of the mixture to escape. The collecting container is arranged around mixer housing 21 that serves as the valve body 86 and whose wall 87 comprises a deviating channel 88. Nonreturn valve 62 is arranged in the dispensing channel 90 of a valve seat part 91. As further appears, the inlet on the cartridge side tapers toward the valve seat.

In the variant of FIG. 10, the circular collecting container 92 of device 93 is directly arranged on the portion of mixer housing 21 that serves as the valve body, housing wall 94 comprising a deviating channel 95, and nonreturn valve 62 in dispensing channel 97 being disposed in a valve seat part 98. The collecting container is closed with a filter 99 and is rotatable or axially displaceable in order to open or close deviating channel 95, and rests on a shoulder 96 in mixer housing 21. In the rotatable version, one half 100D of end wall 100 on the outlet side of the collecting container is thicker than the other half.

FIG. 11 illustrates a variant of the embodiment of FIG. 1 where no collecting container is provided. Device 72 has the same valve body 17 as in FIG. 1 with inlet bore 25 and Luer-Lok connector 4 but may alternatively also comprise the other valve assemblies. In contrast to the other examples, no collecting container is provided but deviating channel 74 on actuating member 73 here leads to a coupling 89 for connecting a suction device or a hose or a collecting balloon.

According the above description, the venting and leveling device follows after the mixing operation. It may be used for static mixers, as shown, or also for dynamic mixers. Furthermore, the device may not only be arranged inside the mixer housing, after the last mixing element, or between the mixer and the following application instrument, but also integrated in the latter.

Instead of the illustrated straight embodiments, versions that are angled after the mixer are also conceivable. Also, the different valves and assemblies may be combined with each other as desired.

The invention described above eliminates the following system inherent weaknesses in multicomponent dispensing appliances:
filling level differences in the cartridge,
air bubbles in the cartridge cylinders,
air in the mixer and in the transfer channel,
the preceding component, and
the incompletely mixed starting phase.

It is therefore possible to use such dispensing appliances also for critical applications in surgery as it is ensured that neither air nor incompletely mixed materials can be applied.

The method and the device have been described with reference to multicomponent dispensing appliances as they are most useful in this case, but an analogous method and an analogous device may as well be used for a single component dispensing appliance, in which case the venting and the elimination of the unwanted starting phase, which may e.g. also contain air bubbles, are of particular importance.

The differences in the devices according to the drawings are e.g. found in the use of an outlet nozzle instead of a mixer in FIGS. 1, 2, and 5, and furthermore in the use of a cartridge having a single storage container instead of double cartridge 19 in FIG. 1. The remaining parts may be the same. However, the device of the invention may also be arranged in a different location of the dispensing appliance, e.g. on the application instrument.

1. A method for venting and eliminating liquid material of a dispensing appliance prior to dispensing, the method comprising:
eliminating air as well as unusable material via a deviating channel; and
dispensing the conditioned material via a dispensing channel.

2. A method according to claim 1 for venting, leveling, and eliminating incompletely mixed components after the mixing operation of at least two components, the air and the incompletely mixed materials being eliminated via a deviating channel and the vented, leveled, and mixed materials being dispensed via a dispensing channel.

3. A method according to claim 1, wherein after the venting and the elimination of the unusable or non-leveled material, the material is conducted into the dispensing channel by actuating a valve assembly.

4. A method according to claim 1, wherein the pressure of the dispensed material is previously specified and is limited, signaled, or indicated.

5. A device for venting a dispensing appliance and eliminating unusable liquid material therein, the device comprising:
a valve assembly for selectively connecting the inlet area of the device with a deviating channel or with an outlet.

6. A device according to claim 5 for venting, leveling, and eliminating the liquid material after the mixing operation in a multicomponent dispensing appliance comprising a multicomponent syringe or cartridge and a mixer, wherein the device that is arranged after the mixer elements is provided with a valve assembly for selectively connecting the area after the mixing elements with a deviating channel or with the mixer outlet.

7. A device according to claim 4, wherein the device includes a pressure relief assembly that is arranged after the mixer elements and is configured such that a previously specifiable pressure during dispensing is not exceeded, is signaled, or indicated.

8. A device according to claim 7, wherein the pressure relief assembly comprises a relief channel that is connected to the deviating channel and is terminated by a pressure relief valve.

9. A device according to claim 7, wherein the pressure relief assembly comprises a relief channel that is connected to the deviating channel and in or on which a signaling device or a display device is arranged.

10. A device according to claim 5, wherein a collecting container is connected to the deviating channel.

11. A device according to claim 10, wherein the collecting container is closed with a filter that is impermeable to the material and permeable to air.

12. A device according to claim 11, wherein the collecting container is closed with a filter that is arranged between the container and a cover and is impermeable to the material and permeable to air, the cover having at least one opening.

13. A device according to claim 5, wherein the device is designed as a unit can be pushed on a mixer.

14. A device according to claim 5, wherein the valve body of the valve assembly is formed integrally with the mixer housing.

15. A device according to claim 5, wherein the device is connectable on its outlet side to an application instrument.

16. A device according to claim 5, wherein the valve assembly includes a movable valve member that is arranged inside the valve body and provided with a deviating channel and a dispensing channel, the movable valve member being capable of being selectively brought to respective positions in which the area after the mixer elements is connected to the deviating channel or to the dispensing channel.

17. A device according to claim 16, wherein the linearly movable valve member is arranged in a transversal bore in the valve body.

18. A device according to claim 17, wherein the linearly movable valve member is loaded by a compression spring.

19. A device according to claim 16, wherein the linearly movable valve member is a nonreturn valve.

20. A device according to claim 16, wherein the rotationally movable valve member is arranged in a transversal bore in the valve body.

21. A device according to claim 5, characterized in that the collecting container is integrally connected to the movable valve member.

22. A device according to claim 16, wherein the circular collecting container is connected to the valve body.

23. A device according to claim 22, wherein the circular collecting container is made of a material that is permeable to air but impermeable to the material.

24. A device according to claim 16, wherein the circular collecting container is connected to the mixer housing.

25. A device according to claim 24, wherein the collecting container is arranged on the mixer housing in a longitudinally displaceable or rotatable manner for opening or closing the deviating channel.

26. A device according to claim 5, wherein the deviating channel of the collecting container is provided with a coupling means for a suction device or a hose or a collecting balloon.

27. A device according to claim 5, wherein the valve body is provided on its outlet side with interfaces for following application instruments.

28. A device according to claim 10, wherein the collecting container is arranged concentrically or eccentrically to the longitudinal center axis of the movable valve member or of the mixer housing and in the longitudinal axis or at an angle with respect to the longitudinal axis of the movable member.

29. A device according to claim 10, wherein a splash guard is arranged in the collecting container.

30. A filter assembly for a device for venting and eliminating liquid material in a dispensing appliance prior to dispensing, comprising
a collecting container,
wherein the filter is arranged between the collecting container and an associated cover, the cover having at least one opening and the surface of the cover that is facing the filter having a surface structure that allows conducting the air that is flowing through the filter to the outlet opening from any position, the filter being impermeable to the material and permeable to air.

31. A filter assembly according to claim 30, wherein the filter is hydrophobic or porous or provided with fine channels.
